(19) United States
(12) Patent Application Publication
(10) Pub. No.: US 2001/0023407 A1
(43) Pub. Date: Sep. 20, 2001

(54) Method and apparatus for distributing and redeeming offers and incentives

(75) Inventors: Dak Liyanearachchi, Oxfordshire (GB); Kevin A. Mills, Buckinghamshire (GB)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Catalina Marketing International, Inc., St. Petersburg, FL

(21) Appl. No.: 09/795,488

(22) Filed: Mar. 1, 2001

(30) Foreign Application Priority Data
Mar. 14, 2000 (GB) 6156.4

(51) Int. Cl. G06F 17/60

(52) U.S. Cl. 705/14

(57) ABSTRACT

A method and system for distributing promotional offers and other incentives to consumers over a communication network and for the consumers subsequently to redeem at least some of the offers is disclosed. The invention includes storing manufacturers offers and/or retail incentives in a database C associated with a co-operative communication network site 2 and providing information from the database to a consumer in a response to a request from a consumer to the database. The consumer may be connected directly to the database or may be given access to the database while logged into a retailer's or manufacturer's network site in such a way that the consumer is not aware that information is coming from the co-operative communication site. In addition, a transactional second database D is provided for recording transactions on the first database C so that when a consumer selects offers, step 27, from the database, an order is generated, step 28, on the transactional database. This order is passed to the retailer's on-line check out, step 30, and the transactional database is further updated, step 31, with any unfulfilled orders. Invoicing data is then produced from the transactional database for invoicing manufacturers and other suppliers for manufacturer's offers redeemed by retailers, and in addition, in an embodiment of the invention, marketing analysis reports are generated from the transactional database.

This invention is related to the delivery of promotional incentives and other information to online shoppers from a co-operative communication network site.

Home shopping is becoming increasingly popular. With significantly increasing penetration of Internet access, Internet-enabled mobile phones and digital interactive television, use of this method of shopping will further expand.

Although retailers are developing discounted offers online, there is no web site where offers and incentives are product-oriented rather than retailer oriented, where, for example, a consumer can select or pre-define a retailer with whom to use an offer.

Methods are known of delivering discount coupons to consumers over a communications network such as the Internet for printing locally. However these methods are not suitable for providing an immediate discount for online shopping.

A method is known from EP-A-0986016 of distributing product offers and other information to consumers over a communications network. The method involves a co-operative communications network site, such as a web site, including a database of manufacturers' offers and retailers' incentives. Information is then provided from the co-operative communication network site to a consumer who logs into the co-operative site Alternatively, the information may be provided to the consumer from the co-operative site while the consumer is logged into a retailer's or manufacturer's site, without the consumer being aware that the information has come from another site. That is, the transfer of information from the co-operative site is hidden or transparent to the consumer. This information may include offers from which the consumer may choose selected offers. The method may also include a database for holding consumers' purchasing preferences or purchasing history, so that incentives and offers may be targeted to a consumer.

There is no disclosure in EP-A-0986016 of the application of the method to online shopping, using, for example, the Internet, Internet-enabled mobile phones or interactive television, nor of any automated means of retailers invoicing manufacturers or other suppliers to reclaim funds for manufacturers' offers they have redeemed.

It is an object of the invention to at least partially overcome these deficiencies.

According to a first aspect of the invention there is provided a method of communicating data for distributing product offers and other incentives to consumers over a communication network to enable redemption of at least some of the offers or incentives and for generating invoicing data for invoicing a supplier of the redeemed offer or incentive, comprising the steps of: a) storing data representing the conditions of manufacturers' offers and/or of retailer incentives in a first database associated with a co-operative communication network site, b) providing data from the first database to a consumer in response to a consumer request made directly or indirectly to the first database from a consumer communication node connected to the communication network, irrespective of whether the consumer communication node is logged into the co-operative communication site or to a retailer or manufacturer network site or another independently administered site, c) providing a transactional second database for recording data transactions on the first database, d) receiving data representing selections made by the consumer from the offers and/or incentives and transmitting the selections data over the communications network to a retailer's network site in order to complete purchases corresponding to the selections and updating said transaction database with the selections, e) further updating the transaction database in respect of any selections for which purchases were not fulfilled by the retailer, and f) generating invoicing data from the transaction database for invoicing manufacturers and/or suppliers for manufacturers' offers redeemed by retailers.

Preferably step b) further comprises the step of selectively providing data to the consumer relating to retailers whose delivery areas cover the consumer's location.

Conveniently, step a) further comprises the step of storing in the first database associated with the co-operative communication network site consumer data relating to preferences established by consumers, and step b) further comprises the step of providing data corresponding to consumer specific offers or incentives dependent on the stored consumer preferences.

Advantageously, step a) further comprises storing in the first database associated with the co-operative communication network site consumer data representing purchasing histories and/or interest groups, and step b) further comprises the steps of identifying the consumer and of providing data corresponding to consumer-specific offers or incentives dependent on the stored consumer purchasing histories and/or interest groups.

Preferably step b) includes the steps of monitoring the consumer's behaviour while communicating, either directly or indirectly, with the co-operative communication site, and step e) includes the step of providing manufacturers and/or retailers with analysis reports of consumer behaviour in respect of offers or incentives from the respective manufacturers or retailers.

According to a second aspect of the invention, there is provided a system for distributing product offers and other incentives to consumers over a communication network and for the consumers subsequently to redeem at least some of the offers, comprising: storage means for storing the conditions of manufacturers' offers and/or of retailer incentives in a first database associated with a co-operative communication network site, output means for providing data from the first database to a consumer in response to a consumer request made directly or indirectly to the first database from a consumer communication node connected to the communication network, irrespective of whether the consumer communication node is logged into the co-operative communication site or to a retailer or manufacturer network site or another independently administered site, a transactional second database for recording transactions on the first database, selection means for making selections by the consumer from the offers and/or incentives, transmission means for transmitting the selections over the communications network to a retailer's network site in order to complete purchases corresponding to the selections and updating said transaction database with the selections, updating means for further updating the transaction database in respect of any selections for which purchases were not fulfilled by the retailer, and invoicing means for generating invoicing data from the transaction database for invoicing manufacturers and/or suppliers for manufacturers' offers redeemed by retailers.

Preferably output means for providing information from the first database further comprises selection means for selectively providing information to the consumer relating to retailers whose delivery areas cover the consumer's location.

Conveniently storage means for storing the conditions of manufacturers' offers and/or of retailer incentives further comprises means for storing consumer preferences established by consumers, and the output means for providing information from the first database to a consumer in response to a consumer request further comprises selection means for providing consumer-specific offers or incentives dependent on the stored consumer preferences.

Advantageously storage means for storing the conditions of manufacturers' offers and/or of retailer incentives further comprises means for storing consumer purchasing histories and/or interest groups, and the output means for providing data from the first database further comprises means for identifying the consumer and for providing consumer-specific offers or incentives dependent on the stored consumer purchasing histories and/or interest groups.

Preferably output means for providing information from the first database includes monitoring means for monitoring the consumer's behaviour while communicating, either directly or indirectly, with the co-operative communication site, and the updating means for further updating the transaction database includes means for providing manufacturers and/or retailers with analysis reports of consumer behaviour in respect of offers or incentives from the respective manufacturers or retailers.

The invention provides the advantage to a consumer of added incentives from home shopping, for example by providing immediate discounts. Incentives do not have to be claimed subsequent to completing the purchase.

The invention provides the advantage to a retailer of a reliable and cost-efficient invoicing of manufacturers and/or other suppliers such as wholesalers or distributors, for discounts redeemed from online shopping. In addition, new customers are attracted from consumers logging into, for example the co-operative site or a manufacturer's site. The invention, in some embodiments, provides the additional advantages to a retailer of targeting incentives to online shoppers and of receiving marketing promotion feedback, for example, information on what types of incentive attract different types of consumer.

The invention provides to the manufacturer a virtual clearing house for offers with fast redemption feedback and no misredemption or malredemption as well as providing a new channel to market and promote products effectively. The manufacturer also avoids the cost of printing and distributing physical coupons. The manufacturer is also able to change offers much more frequently than with printed coupons. An embodiment of the invention also provides the manufacturer with analysis of what types of offer attract different types of consumers. In addition, because the manufacturer can analyse the effect of offers, the manufacturer can target offers and determine effective thresholds of offers.

The present invention provides cost reductions and other offers which are available only by using the co-operative site, either directly or indirectly through a retailer's, manufacturer's or other independent site, for example from advertising banners on a search engine site.

An embodiment of the present invention will now be described, by way of example only, with reference to the accompanying drawings, in which:

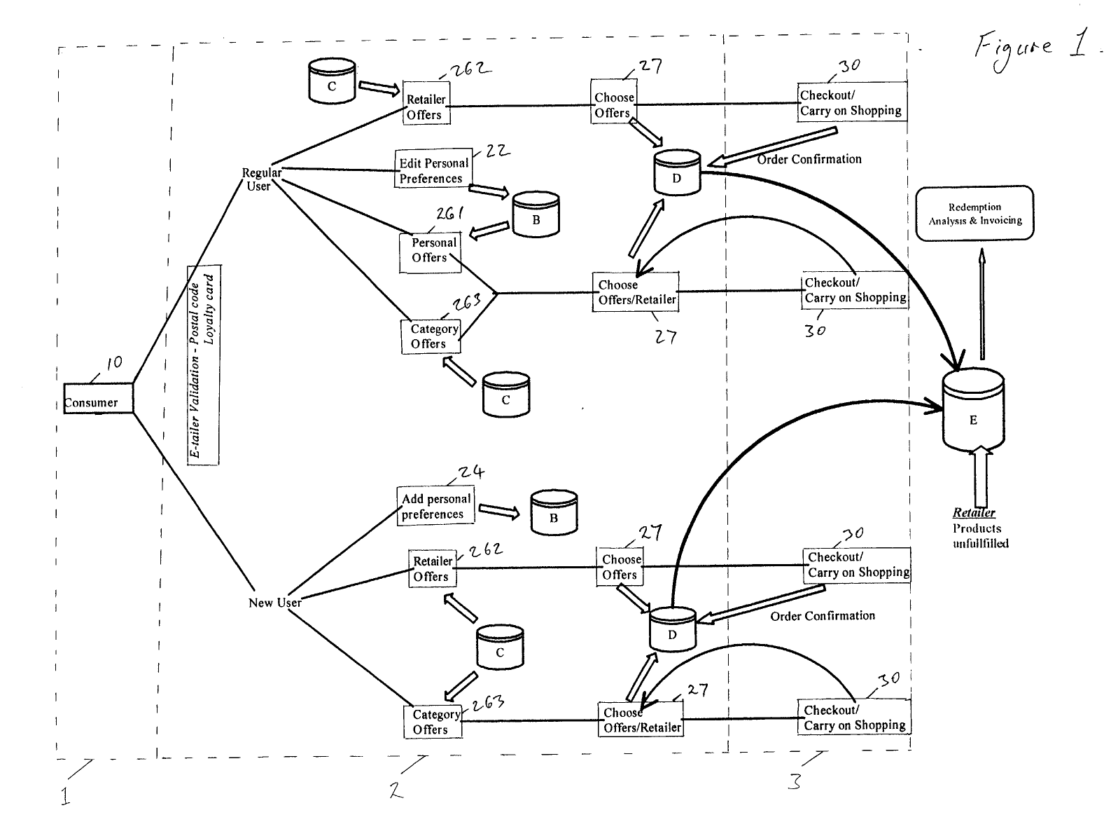

FIG. 1 is a schematic diagram of databases and communication patterns used according to this invention;

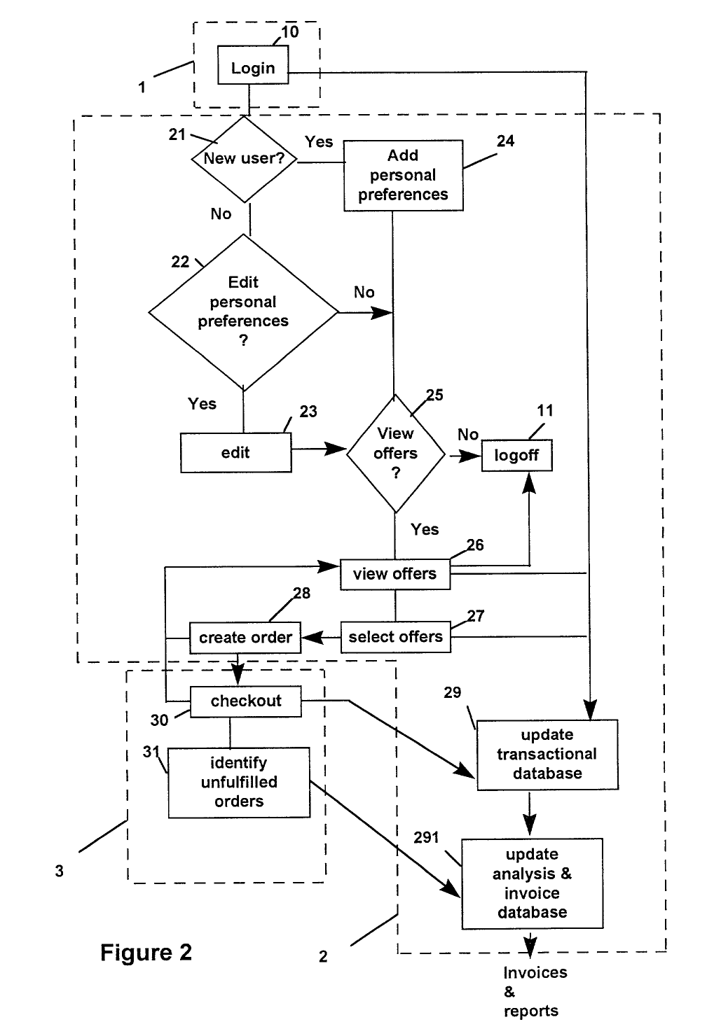

FIG. 2 is of flowchart of the present invention;

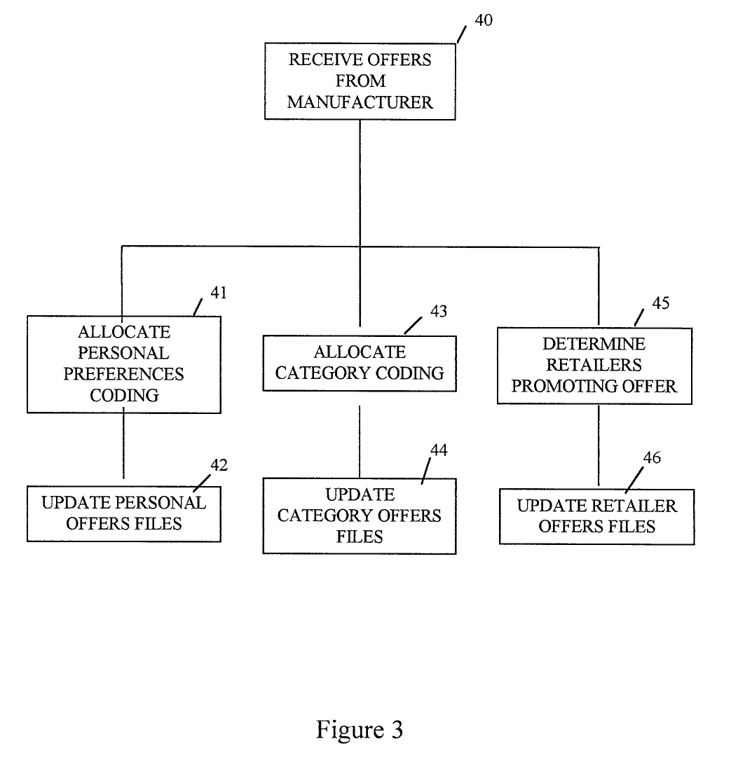

FIG. 3 is a block schematic of the means of updating the database associated with a co-operative communication network site of the invention with manufacturers' offers; and

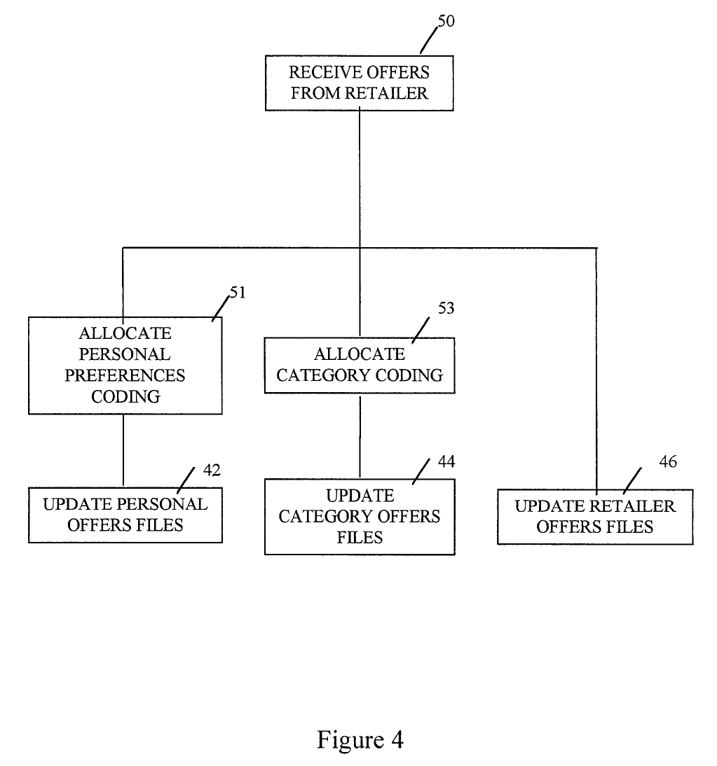

FIG. 4 is a block schematic of the means of updating the database associated with a co-operative communication network site of the invention with retailers' incentives.

In the Figures like numerals represent like parts.

As shown in FIG. 1, this invention employs steps performed on a log-on Internet site 1, a co-operative Internet site 2 and a retailer's Internet site 3. It will be understood that although this embodiment is described in relation to the Internet, or World-Wide Web, including Internet-enabled mobile phones, the invention is also applicable to, for example, an interactive television network.

Manufacturers' offers and retailers' incentives are held on an offers database C associated with the co-operative Internet site 2. This database also holds price data and delivery charges for the products that are subject to offers or incentives. Also associated with the co-operative Internet site is a preferences database B of consumers' personal preferences, purchasing histories and/or interest groups. This data may include consumers' preferred retailers so that manufacturer offers available from more than one retailer may be tailored to a consumer's preferences.

The offers database C is so organised that on interrogation offers and incentives corresponding to a specific retailer may be output, or corresponding to a plurality of retailers organised by retailer. Alternatively the offers and incentives may be output for specific product categories. Moreover, where a consumer's preferences, purchasing history and/or interest groups are held on the preferences database B, offers or advertising banners may be output dependent on those preferences, that purchasing history and/or those interest groups.

Referring to FIG. 2, a consumer may access the co-operative Internet 2 directly by logging into, step 10, a log-on site 1 using an access device or terminal such as a PC, Internet-enabled mobile phone or interactive television or may, transparently to the consumer, be given access to the co-operative site 3, while being logged into a retailer's or manufacturer's site. For example, while the consumer is logged into a retailer's site the consumer may request incentives available and the retailer's site 3 will interrogate the co-operative site 2 for offers and incentives available via that retailer from manufacturers and/or incentives from that retailer and will present only those offers to the consumer while the consumer is still in the retailer's site. Similarly, while logged into a manufacturer's site the consumer may interrogate the co-operative database and be presented with the offers available from that manufacturer and the details of retailers carrying the offers, while remaining logged into the manufacturer's site, without being aware that the information has come from the co-operative site. The consumer may, preferably, be presented only with offers from those retailers in whose delivery areas he is located, in a manner to be described.

On logging in, a record is created in a transactional database D to monitor the use made of the co-operative site 3. Following logging into, step 10, the co-operative site 2, either directly or indirectly via a retailer's, manufacturer's or independent site, a determination, step 21, is made whether the consumer is already known to the preferences database B. This may be done, for example, by requesting a user identification or by means of a “cookie” previously downloaded from the co-operative site onto the user's terminal by which he is connected to the network. If the consumer is recognised, the consumer may be invited to update, step 22, his personal preferences, if any. If it is determined that the consumer is a new user, or a known user with no registered preferences, he may be invited to record, step 24, his preferences on the preferences database B (see FIG. 1).

Unrecognised users may also be asked for their geographical location, for storage in the preferences database B, in order to determine within which retailers' delivery areas the consumer is located. It will be appreciated that this step may be omitted for mail order retailers willing to mail goods world-wide. If it is determined that the consumer's location is outside all of the participating retailers' delivery areas, a facility may be provided, not shown, to inform the consumer, for example by e-mail, when a retailer in the consumer's area begins to participate, or to offer alternative means of obtaining discounts, such as printing out discount coupons for presenting at a non-online retail store.

The consumer is invited, step 25, to view any available offers. On agreeing to view offers the consumer is presented, step 26, with personal offers 261, retailer incentives 262 or product category offers 263. The user may select, step 27, offers of interest or logoff from, step 11, or otherwise leave the co-operative site 2. That is, the consumer may view offers from a single retailer (particularly if logged into that retailer's site) or by a category of products, whereby the consumer can compare offers (and preferably delivery charges) available from different retailers, or personal offers dependent on the consumer's expressed preferences, purchasing history and/or interest groups.

On viewing or selecting offers or incentives, step 27, a transaction database D is updated, step 29, with the consumer's actions and with the selected offers by order number and the offers are also passed, step 28, to the retailer site 3 with the allocated order number, where they form items in a basket of goods associated with the consumer. If the consumer chooses offers from more than one retailer, it is necessary for the consumer subsequently to visit each of the retailers' checkouts from which offers have been chosen to purchase the products which are subjects of the chosen offers. This is because the consumer is effectively filling more than one shopping basket in choosing the offers. Preferably, only offers made by retailers in whose delivery areas the consumer is located are presented to the consumer.

The data passed to the retailer site 3 may include the order reference, customer identifier, European Article Number, quantity of product and offer details. The transaction database D then updates an invoicing and analysis database E with the details of the order. The consumer may add other goods to this basket from the retailer's site before passing to the checkout. At the checkout the consumer purchases, step 30, the goods in the basket by authorising payment or a debit. An acknowledgement of the completed order is sent by the retailer to the transaction database D and details of any offers included in the basket that cannot be purchased at the checkout, for example because the retailer is out of stock, are identified 31 and transmitted to the invoicing and analysis database E. The consumer may then carry on shopping or log out of the site.

Invoices are generated from the invoicing and analysis database E for presentation to manufacturers to reimburse retailers for manufacturers offers they have redeemed. In addition reports are generated for manufacturers and retailers on, for example, the take-up rate of offers and incentives, to add their marketing planning and to determine whether to maintain or cease offers or incentives. In addition, socio-economic analysis may be performed on the take-up of offers where demographic data or other suitable data is stored in the preferences database or otherwise associated with the purchases. Thus the data can be used to analyse consumer buying habits and provide feedback on what types of offers attract different types of consumer. This data may be used to target offers to regular customers. This data may be generated whether or not the consumer selected any of the presented offers. In addition, facilities may be made available for manufacturers to log into the co-operative site to monitor the take-up of their offers, so that they may review their offers on the basis of their success to date.

Information on consumers' preferences or purchasing history may also be made available to third parties for their own targeted marketing, for example, information on purchasers of baby foods may be made available to a child car seat supplier.

This invention requires updating of the co-operative site database C with information on retailers' incentives and manufacturers' offers. This process is schematically illustrated for manufacturer's offers in FIG. 3. The co-operative site receives, step 40, details of offers from the manufacturer, either electronically or on paper and allocates, step 41, personal preference coding by which the offer may be retrieved corresponding to a consumer's personal preferences, purchasing history and/or interest groups. This coded data may then be used to update a file 42 of personal offers. Similarly, product category coding is allocated, step 43, to update a category offers file 44 for subsequent retrieval of offers by product category. The co-operating retailers who are promoting the manufacturer's offer are also determined, step 45, to update a retailer offers file 46.

As shown in FIG. 4, an analogous process is undertaken to update the offers database C with a retailer's incentives, except that there is no requirement to identify retailers offering the incentive, since the incentive details are received directly from a co-operating retailer. Therefore, the co-operative site 2 receives, step 50, details of offers from the retailer, either electronically or on paper and allocates, step 51, personal preference coding by which the offer may be retrieved corresponding to a consumer's personal preferences, purchasing history and/or interest groups. This coded data may then be used to update the file 42 of personal offers. Similarly, product category coding is allocated, step 53, to update a category offers file 44 for subsequent retrieval of offers by product category. The offer details are also used to update the retailer offers file 46.

As indicated above, the personal offers file 42, the category offers file 44 and the retailer offers file 46 may constitute a single database from which offers may be displayed in the different formats of personal offers, category offers and retailer offers.

1. A method of communicating data for distributing product offers and other incentives to consumers over a communication network to enable redemption of at least some of the offers or incentives and for generating invoicing data for invoicing a supplier of the redeemed offer or incentive, comprising the steps of:
a) storing data representing the conditions of manufacturers' offers and/or of retailer incentives in a first database associated with a co-operative communication network site,
b) providing data from the first database to a consumer in response to a consumer request made directly or indirectly to the first database from a consumer communication node connected to the communication network, irrespective of whether the consumer communication node is logged into the co-operative communication site or to a retailer or manufacturer network site or another independently administered site,
c) providing a transactional second database for recording data transactions on the first database,
d) receiving data representing selections made by the consumer from the offers and/or incentives and transmitting the selections data over the communications network to a retailer's network site in order to complete purchases corresponding to the selections and updating said transaction database with the selections,
e) further updating the transaction database in respect of any selections for which purchases were not fulfilled by the retailer, and
f) generating invoicing data from the transaction database for invoicing manufacturers and/or suppliers for manufacturers' offers redeemed by retailers.

2. A method as claimed in claim 1 wherein step b) further comprises the step of: selectively providing data to the consumer relating to retailers whose delivery areas cover the consumer's location.

3. A method as claimed in claims 1 or 2, wherein step a) further comprises the step of storing in the first database associated with the co-operative communication network site consumer data relating to preferences established by consumers, and step b) further comprises the step of providing data corresponding to consumer specific offers or incentives dependent on the stored consumer preferences.

4. A method as claimed in any of the preceding claims wherein: step a) further comprises storing in the first database associated with the co-operative communication network site consumer data representing purchasing histories and/or interest groups, and step b) further comprises the steps of identifying the consumer and of providing data corresponding to consumer-specific offers or incentives dependent on the stored consumer purchasing histories and/or interest groups.

5. A method as claimed in any of the preceding claims wherein step b) includes the steps of monitoring the consumer's behaviour while communicating, either directly or indirectly, with the co-operative communication site, and step e) includes the step of providing manufacturers and/or retailers with analysis reports of consumer behaviour in respect of offers or incentives from the respective manufacturers or retailers.

6. A system for distributing product offers and other incentives to consumers over a communication network and for the consumers subsequently to redeem at least some of the offers, comprising: storage means for storing the conditions of manufacturers' offers and/or of retailer incentives in a first database associated with a co-operative communication network site, output means for providing data from the first database to a consumer in response to a consumer request made directly or indirectly to the first database from a consumer communication node connected to the communication network, irrespective of whether the consumer communication node is logged into the co-operative communication site or to a retailer or manufacturer network site or another independently administered site, a transactional second database for recording transactions on the first database, selection means for making selections by the consumer from the offers and/or incentives, transmission means for transmitting the selections over the communications network to a retailer's network site in order to complete purchases corresponding to the selections and updating said transaction database with the selections, updating means for further updating the transaction database in respect of any selections for which purchases were not fulfilled by the retailer, and invoicing means for generating invoicing data from the transaction database for invoicing manufacturers and/or suppliers for manufacturers' offers redeemed by retailers.

7. A system for distributing product offers and other incentives as claimed in claim 6 wherein the output means for providing information from the first database further comprises selection means for selectively providing information to the consumer relating to retailers whose delivery areas cover the consumer's location.

8. A system for distributing product offers and other incentives as claimed in claims 6 or 7, wherein the storage means for storing the conditions of manufacturers' offers and/or of retailer incentives further comprises means for storing consumer preferences established by consumers, and the output means for providing information from the first database to a consumer in response to a consumer request further comprises selection means for providing consumer-specific offers or incentives dependent on the stored consumer preferences.

9. A system for distributing product offers and other incentives as claimed in any of claims 6 to 8 wherein: the storage means for storing the conditions of manufacturers' offers and/or of retailer incentives further comprises means for storing consumer purchasing histories and/or interest groups, and the output means for providing data from the first database further comprises means for identifying the consumer and for providing consumer-specific offers or incentives dependent on the stored consumer purchasing histories and/or interest groups.

10. A system for distributing product offers and other incentives as claimed in any of claims 6 to 9 wherein the output means for providing information from the first database includes monitoring means for monitoring the consumer's behaviour while communicating, either directly or indirectly, with the co-operative communication site, and the updating means for further updating the transaction database includes means for providing manufacturers and/or retailers with analysis reports of consumer behaviour in respect of offers or incentives from the respective manufacturers or retailers.

11. A computer program comprising code means for performing all the steps of the method of any of claims 1 to 5 when the program is run on one or more computers.

12. A computer program as claimed in claim 11, wherein the computer program is embodied on a computer-readable medium.

13. A computer program product comprising program code means stored in a computer-readable medium for performing the method of any of claims 1 to 5 when that program product is run on one or more computers.

14. A method for distributing product offers and other incentives substantially as described herein with reference to and as illustrated in the accompanying drawings.

15. A system for distributing product offers and other incentives substantially as described herein with reference to and as illustrated in the accompanying drawings.
